(19) United States
(12) Patent Application Publication
(10) Pub. No.: US 2009/0300968 A1
(43) Pub. Date: Dec. 10, 2009

(54) BAIT STATION FOR TERMITE CONTROL

(75) Inventors: Mark Zajac, Greensboro, NC (US); James Swanson, Greensboro, NC (US)

Correspondence Address: SYNGENTA CROP PROTECTION , INC.;PATENT AND TRADEMARK DEPARTMENT, 410 SWING ROAD, GREENSBORO, NC, 27409, US

(73) Assignee: SYNGENTA CROP PROTECTION, INC., Greensboro, NC (US)

(21) Appl. No.: 12/282,523

(22) PCT Filed: Mar. 9, 2007
(86) PCT No.: PCT/US2007/063640

§ 371 Date: Feb. 11, 2009

Related U.S. Application Data
(60) Provisional application No. 60/782,122, filed on Mar. 14, 2006.

(51) Int. Cl. A01M 17/00

(52) U.S. Cl. 43/132.1

(57) ABSTRACT

The present invention is directed to a device for monitoring, detecting and/or controlling subterranean termites comprising an outer housing adapted to be implanted in the ground having a plurality of openings through a side wall of the outer housing for passage of termites through the openings into an interior of the outer housing; and a bait cartridge comprising a major amount of a termite edible material and a minor amount of a termite resistant material, wherein the termite edible material comprises at least two different forms of a cellulose containing material; and, optionally, a termite-edible sleeve engaged with the side wall of the outer housing and covering at least a portion of said side wall, which sleeve comprises a cellulose containing material having substantially the same form as at least one of the cellulose containing materials from which the bait cartridge is formed.

### FIELD OF THE INVENTION

The present invention relates to in-ground termite bait stations for containing termite-edible bait material to monitor and/or control termite activity.

### BACKGROUND

Termites invade houses in their search for cellulosic foodstuffs. The damage to US properties is put at about $1 billion per annum. Various methods have been used to protect buildings from being infested with termites, and many more methods used to rid the buildings of termites once infested.

The market has historically been dominated by pre-construction intensive spray application of long residual pesticides on to a foundation soil surface prior to the laying of the concrete slab over a plastic sheet such as a Damp-Proof Membrane—DPM, vapor barrier, vapor retarder or the like. Such pesticides as organo-phosphates—eg chlorpyrifos, pyrethroids (e.g. cypermethrin and lambda cyhalothrin) have been employed. More recently, products such as imidacloprid and fipronil have been employed. Other, more environmentally acceptable, methods of termite-proofing a dwelling place have also been developed such as establishing physical barriers to termite entry (e.g. stainless steel mesh underlays, thick paints, composite materials). These have usually not contained pesticides.

Some more recent methods of termite control involve baiting the termite colony with a cellulose matrix containing a termite toxicant. Known bait stations include a tubular outer housing that is implanted in the ground with an upper end of the housing substantially flush with the ground level to avoid being damaged by a lawn mower. A tubular bait cartridge containing a quantity of bait material (with or without any toxic active ingredient) is inserted into the outer housing. In one practice, bait stations are installed underground around the perimeter of a building in prime termite foraging areas as a monitoring device to get “hits” (termites and feeding damage). When termite workers are found in one or more stations, a bait material containing a toxic active ingredient is substituted for the monitoring bait. These methods rely upon individual termites feeding on the bait which contains a non-repellent termiticide, and returning to the colony to pass the poison on to other members, killing a portion of the exposed colony. A greater proportion of active stations lead to increased bait consumption so that after several weeks, the colony will start to decline and eventually be eliminated. However, termites that are not attracted to the bait stations may seek out wood in the building to feed on.

Accordingly, despite the availability of existing baiting stations, there exists a need for underground termite bait stations having an increased attractiveness to termites to improve overall bait consumption and ultimately result in faster colony elimination and thus enhanced structural protection.

### SUMMARY OF THE INVENTION

The present invention is directed to a device for monitoring, detecting and/or controlling subterranean termites comprising:
an outer housing adapted to be implanted in the ground having a plurality of openings through a side wall of the outer housing for passage of termites through the openings into an interior of the outer housing;
a bait cartridge comprising a major amount of a termite edible material and a minor amount of a termite resistant material, wherein the termite edible material comprises at least two different forms of a cellulose containing material; and, optionally,
a termite-edible sleeve engaged with the side wall of the outer housing and covering at least a portion of said side wall, which sleeve comprises a cellulose containing material having substantially the same form as at least one of the cellulose containing materials from which the bait cartridge is constructed.

The invention also relates to a termite control system, comprising: a plurality of subterranean termite monitoring or baiting stations, two or more of said stations each including a bait cartridge comprising a major amount of a termite edible material and a minor amount of a termite resistant material, wherein the termite edible material comprises at least two different forms of a cellulose containing material, the second one of the stations being spaced apart from the first one of the stations.

The present invention further relates to a method for reducing termite feeding damage in a wooden structure, comprising: installing a plurality of subterranean termite monitoring or baiting stations around the exterior of said structure, two or more of said stations each including a bait cartridge comprising a major amount of a termite edible material and a minor amount of a termite resistant material, wherein the termite edible material comprises at least two different forms of a cellulose containing material, the second one of the stations being spaced apart from the first one of the stations.

### BRIEF DESCRIPTION OF THE DRAWINGS

Having thus described the invention in general terms, reference will now be made to the accompanying drawings, which are not necessarily drawn to scale, and wherein:

FIG. 1 is an exploded elevation of a device for monitoring, detecting and/or controlling subterranean termites in accordance with one embodiment of the invention;

FIG. 2 is a perspective view of a partially assembled bait station in accordance with one embodiment of the invention;

FIG. 3 is a side view of a termite bait cartridge in accordance with one embodiment of the invention;

FIG. 4 is an enlarged perspective view of the bottom of the termite bait cartridge of FIG. 3;

FIG. 5 is an enlarged perspective view of the bottom of the termite bait station housing of FIG. 2;

FIG. 6 is an enlarged top view of the bait cartridge of FIG. 3;

FIG. 7 is a cross-sectional view taken on line A-A of FIG. 2/FIG. 5;

FIG. 8 is an enlarged top view of another embodiment of the bait station cap shown in FIG. 1;

FIG. 9 is an enlarged side view of the bait station cap of FIG. 8;

FIG. 10 is a side view of a cap removal tool in accordance with one embodiment;

FIG. 11 is a bottom view of the tool shown in FIG. 10; and

FIG. 12 is an exploded view of the bait cartridge of FIG. 3.

### DETAILED DESCRIPTION

While the present invention is susceptible to several embodiments in various forms, there is hereinbelow described in detail certain specific embodiments, with the understanding that the present disclosure is to be considered as merely an exemplification of the present invention, without limitation to the specific embodiments or examples discussed.

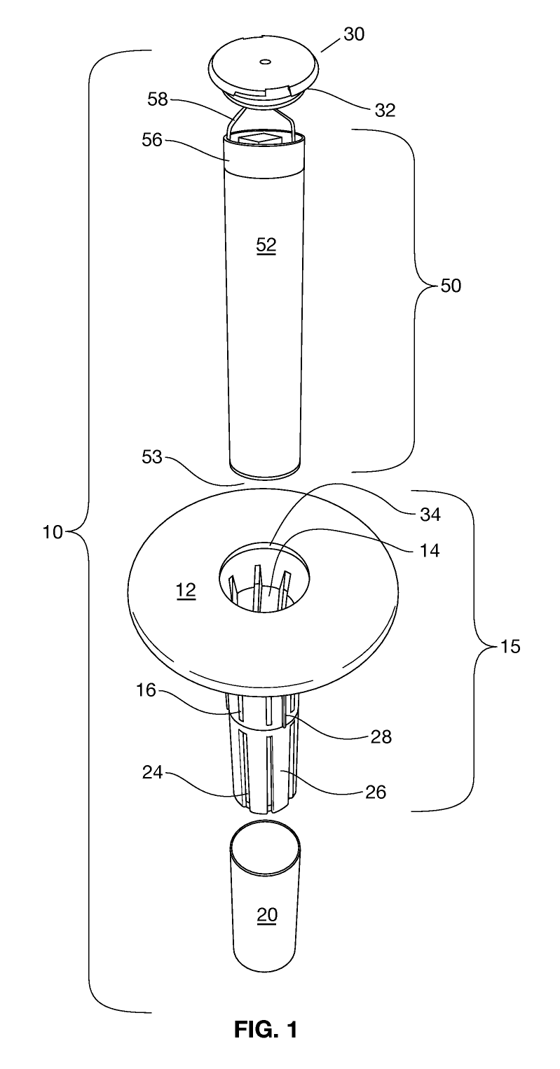

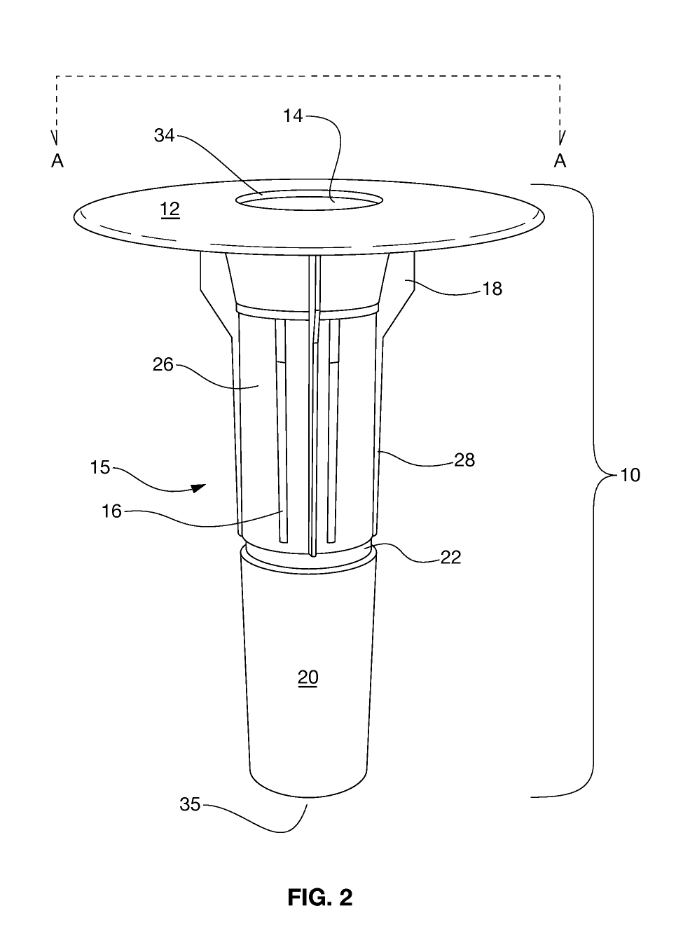

With reference to FIGS. 1 and 2, a termite bait station 10 for monitoring, detecting and/or controlling termite activity is depicted in accordance with one embodiment of the invention. The bait station 10 comprises, inter alia, an outer housing 15, a bait cartridge 50 sized to readily slide into and out of the interior of outer housing 15 via the upper end 14 when the cap 30 is removed, and a cellulosic sleeve 20 which is sized to fit over the lower portion of the sidewall 26 of housing 15. In one embodiment, the sleeve 20 is constructed from a pressed cardboard tube, for example.

The outer housing 15 includes a radially outwardly extending flange or indicator ring 12. In use, a hole corresponding in diameter to that of the lower portion of the housing 15 is opened in the ground, and the housing 15 is inserted into the hole until the indicator ring 12 abuts the upper surface of the ground. One or more anchors 18 (FIG. 2) extend from the sidewall 26 of the housing and serve to fix the orientation of the housing 15 when the station is installed within such hole. As shown in FIG. 2, the tapered end 28 of anchor 18 may also serve as a stop to inhibit sleeve 20 from sliding up the sidewall 26 beyond the midportion 22 when the housing 15 is being inserted into the hole.

The indicator ring 12 provides a visual indication to assist an operator to locate the station for a follow-up inspection or changing a bait cartridge (such as replacing a monitor cartridge with a toxicant containing cartridge). To load the bait station with bait, the bait cartridge 50 is placed into the interior of outer housing 15 via the upper end 14. The cartridge 50 is slid or removeably received into the interior of the housing via the upper end thereof when the cap 30 is removed, and the cover or cap 30 is replaced on the top of the outer housing 15. In one embodiment, the cap 30 comprises a compression ring 32 which engages a recessed lip 34 when the cap is replaced at the upper end 14 of the housing 15.

The outer housing 15 include a sidewall 26 with openings that allow subterranean termites to pass through and access the bait cartridge 50 when it is received therein. More particularly, the outer housing 15 includes a plurality of vertically elongate openings 16, 24 through the side wall 26 of the outer housing. The openings 16, 24 are spaced apart and are arranged in two sets (both upper 16 and lower 24) and comprise a plurality of vertically extending slots that are spaced circumferentially about the side wall 26, as shown. In the illustrated embodiment, there are eight openings 16 and eight openings 24 spaced about the circumference of the side wall 26. It will be understood that this particular arrangement of openings is just one example of a suitable arrangement, and that other arrangements can be used instead.

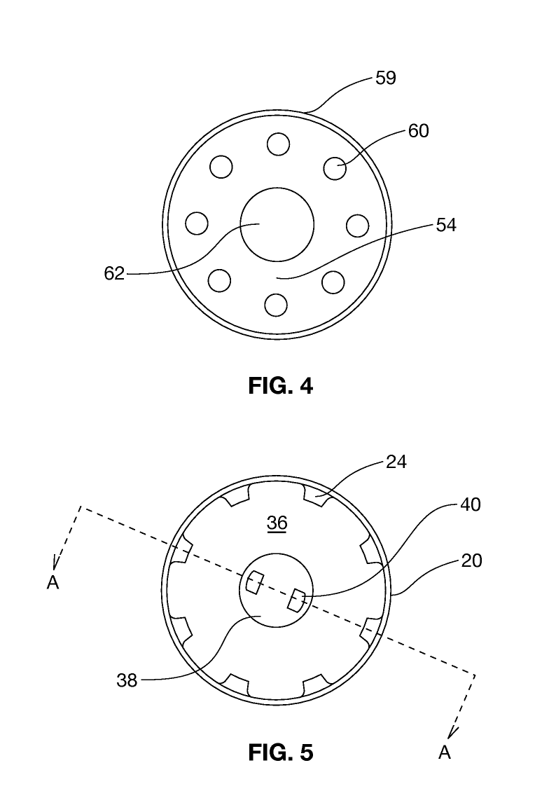

As shown in FIGS. 2, 3, 4 and 5, the bottom end 35 of the outer housing 15 is closed by a bottom wall 36 (FIG. 5), and similarly the bait cartridge 50 has a bottom end 53 that is closed by a bottom wall or reamer 54 (FIG. 4). In addition to closing the bottom end of the bait cartridge, the reamer 54 also serves to clean out debris from the interior of the housing 15 when the bait cartridge 50 is removed during a station inspection and/or to replace the cartridge. To facilitate debris removal, the diameter of reamer base 59 is larger than the diameter of cartridge side wall 52, but still fits within the interior space defined by housing 15. The bottom walls 36, 54 include drainage holes 40 and 60 to allow excess water to drain from the bait station. In one embodiment, the drain holes 40 of housing 15 are located at the bottom tip 38 of the housing 15.

In accordance with the invention, the bait cartridge 50 comprises: (1) a major amount (which means a majority or over 50% by weight; suitably over 70% by weight and more suitably over 80% by weight) of a termite edible material such as a cellulosic material that termites will feed on and/or will attract termites to housing 15; and (2) a minor amount (which means less than 50% by weight) of a termite resistant material such as a polymer material including plastic. In one embodiment, the resistant material provides structural integrity to the bait cartridge 50 during removal of the cartridge, for example, during inspection or replacement of the cartridge during a service visit by a pest control provider. In one embodiment, the resistant components comprise, for example, a flange 56, a reamer 54, and an extractor strap 58.

In accordance with the invention, the termite edible material from which the bait cartridge 50 is constructed comprises at least two different forms or presentations of a cellulose containing material, typically derived from wood and wood based products. Examples of different forms of cellulose containing materials include those that are not repellent to termites such as wood, paper, paperboard, corrugated paper, chipboard, fibreboard, corrugated cardboard, pressed cardboard, recycled materials such as old news paper (ONP) and old corrugated cardboard (OCC), wood flour, and sawdust. Each of the foregoing examples of a cellulose product is considered as a different form of cellulose material for the purpose of the invention. For example, a wood piece, a roll of corrugated cardboard, and a pressed cardboard tube are each considered to be different forms or presentations of a cellulose material for the purpose of the invention. Those skilled in the art will understand that various types of wood may be suitable for use as cellulose materials and each in various forms or presentations as paper, sawdust, wood, corrugated cardboard or pressed cardboard, for example. Examples of suitable wood include hardwoods and softwoods such as, for example, basswood, aspen, cottonwood, paper birch, soft maple, yellow poplar (tulip poplar), beech, pecan, hard maple, persimmon, southern yellow pine, balsam fir and Engelmann spruce. The various distinct cellulose forms or presentations can be derived from these examples of wood sources.

Those skilled in the are will appreciate, for example, that wood based products such as paper made from one wood type (such a particular species or type: hardwood/softwood, etc.) will have different properties (such as fibre size, compression strength, puncture resistance and the like) than the properties associated with a similar product made from another wood type. Accordingly, by way of example, a pressed cardboard made from a hardwood source would be considered as a different form or presentations of a cellulose containing material than a pressed cardboard made from a softwood source.

The optional cellulose sleeve 20 also is constructed from a cellulose material. Examples of suitable materials include those derived from at least one of the foregoing wood and wood based products mentioned above in relation to the cartridge 50. In one embodiment, the sleeve 20 is constructed from a cellulose containing material substantially identical to at least one of the specific forms or presentations included within the cartridge 50.

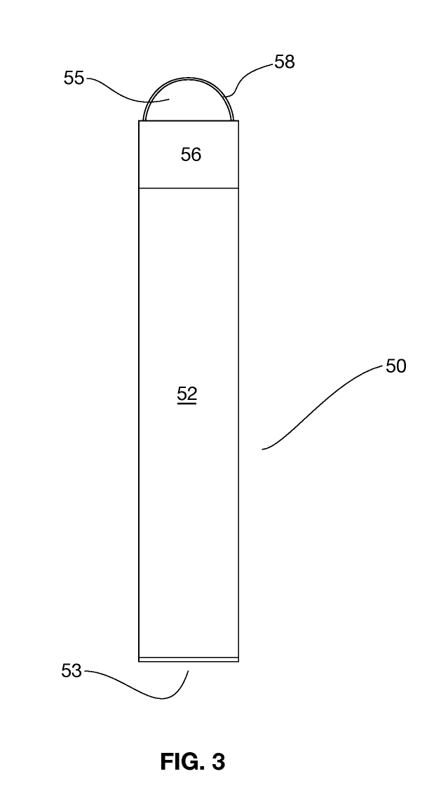

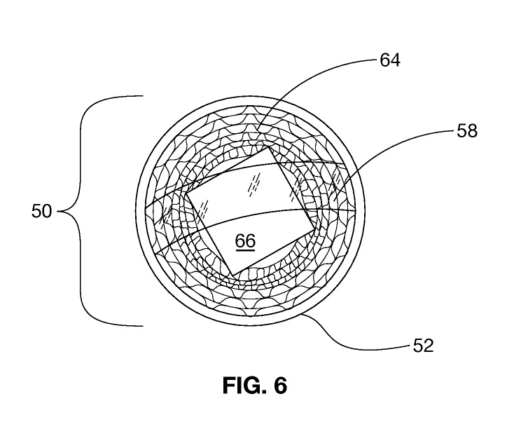

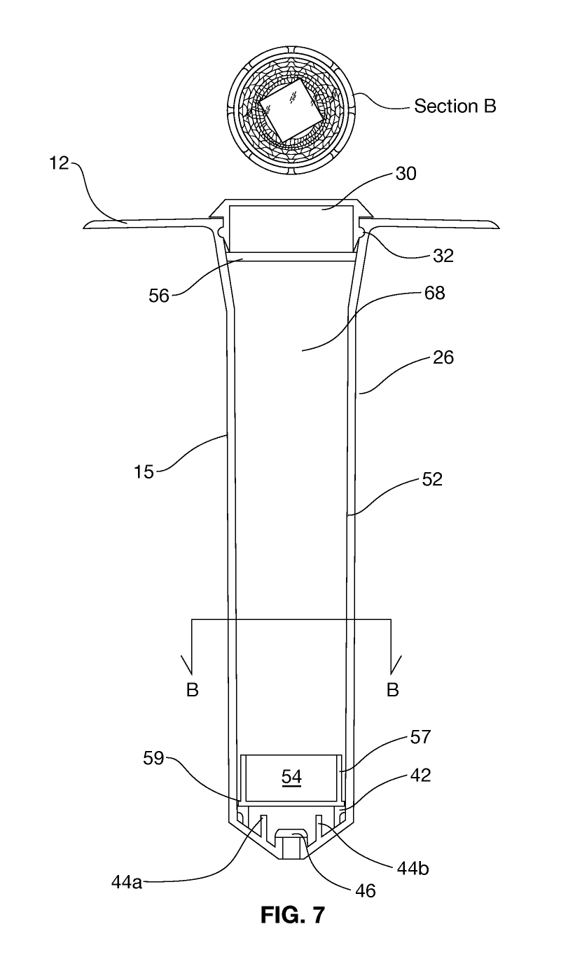

As shown in FIG. 3, a bait cartridge 50 comprising a major amount of termite-edible substance is shown which comprises at least two different forms of cellulose containing materials. The cartridge 50 has a side wall 52 composed of a pressed cardboard tube extending from a lower end 53 to an upper end 55. In one embodiment, the upper end 55 of the tube is open (FIG. 6) and is reinforced by a plastic flange 56. The side wall 52 defines an interior space 68 (FIG. 7) adapted to contain at least one additional form of a cellulose containing material. For example, as shown in FIG. 6, a top view of the open upper end 55 of cartridge 50 reveals that the interior space defined by pressed cardboard side wall 52 contains a corrugated cardboard 64 rolled around a piece of wood 66. Suitable wood sources such as pine are described above. The plastic extractor strap 58 is also shown. In this embodiment, a bait cartridge 50 comprising a major amount of termite-edible substance is shown which comprises at least three different forms or presentations of a cellulose containing material: pressed cardboard, corrugated cardboard and wood.

FIG. 7 depicts a cross-sectional view of station 10 along the section A-A (FIGS. 2, 5) except that the cap 30 is shown in its attached position with compression ring 32 engaging an interior lip of the housing 15. Features visible in the cross-sectional view include a side wall 57 and a base 59 of plastic reamer 54. The reamer base 59 of cartridge 50 rests on bait cartridge stops (42a, 42b) when the cartridge is fully inserted into the interior 68 of housing 15 so that cartridge bottom end 53 rests above drain guides (44a, 44b) and of bottom post 46. A further cross-section B along the section B-B reveals the various layers of materials (including cellulose materials) located within the interior 68 when the cartridge 50 is in its installed condition.

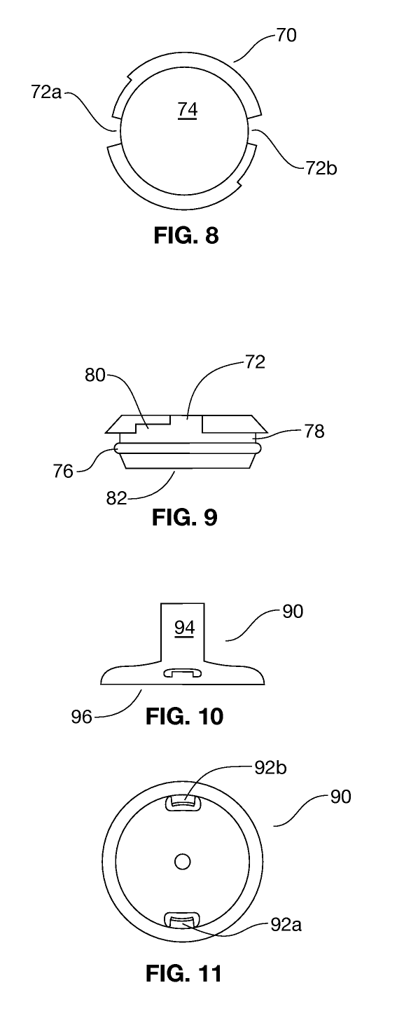

FIGS. 8-11 illustrate a specific embodiment of the station cap 70 which includes slots (72a, 72b) for receiving the plastic tab interlocks (92a, 92b) of cap removal tool 90. To remove the cap 70, the base 96 of tool 90 is positioned over the top 74 of the cap such that tabs 92(a,b) line-up with slots 72(a,b). The tool is moved so that the tabs 92 slide down through the slots 72(a,b) along cap side wall 78; then the tool is twisted in a clockwise motion to engage the tabs 92 with notches 80. A minimal rocking motion is then used to dislodge compression ring 76 from recessed lip 34 and thereby remove the cap 70 from station 10 for service or inspection. In this way, the cap can be removed from the station without twisting or lifting which reduces disturbance of termites that may be feeding on cellulose materials within the station.

In addition, in one embodiment the removed cap stays affixed to the removal tool which also may advantageously be attached to an extension rod (not shown) via post 94. The rod can be of sufficient length so that a worker may remove the cap 70 from a standing position. Those skilled in the art will also appreciate that the cap 70 can be reattached to the station 10 without being specifically oriented other than by placing the bottom 82 of the cap toward the upper end 14 of the station housing (as the compression ring 76 can engage recessed lip 34 from any orientation). This feature of the station facilitates ease of inspection and servicing.

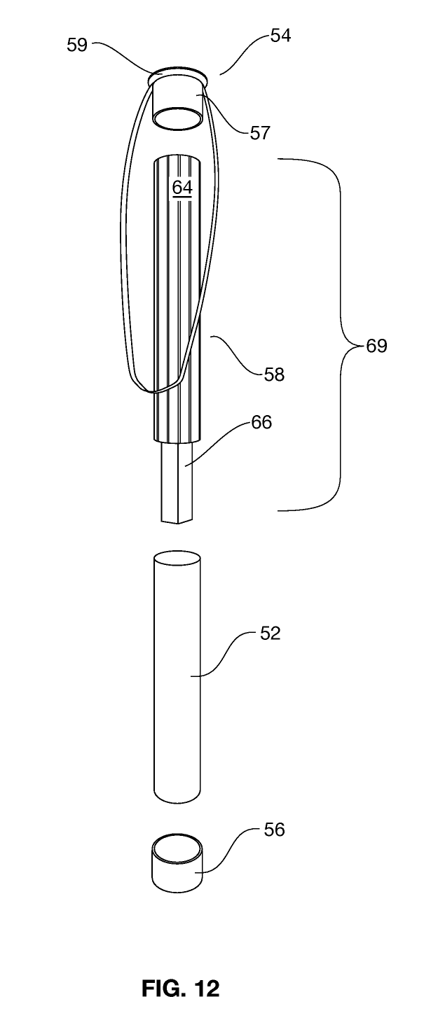

FIG. 12 depicts an exploded view of one embodiment of a bait cartridge in accordance with the invention and oriented in an upside down position. Thus, plastic flange 56 has an interior diameter that is larger than the diameter of side wall 52 (which is shown as a tube of pressed cardboard) so that the flange 56 will slide over and frictionally engage the upper end of the side wall 52 of the tube. Correspondingly, corrugated cardboard 64 is rolled tightly around wood piece 66 so that the interior cellulose assembly 69 will fit within the interior space formed by side wall 52 as well as within the interior space formed by the side wall 57 of the plastic reamer 54.

In the embodiment shown in FIG. 12, the diameter of the side wall 57 of the plastic reamer 54 is smaller that the interior diameter of the side wall 52 (pressed cardboard tube) so that the reamer fits/slides within the bottom end 53 of the tube. In the embodiment shown, the reamer base 59 has a diameter which is wider than the outer diameter of side wall 52 to facilitate removal of debris from the station when the cartridge is removed and/or replaced. Also, the two ends of plastic extraction strap 58 extend through holes (not shown) on opposite sides of side wall 57 and are joined/fastened by a snap rivet 62 (FIG. 4). In the assembled configuration, the strap extends upwardly along the outside of assembly 69 and within the interior of side wall 52 to form an upwardly projecting handle out of the open upper end 55 of the bait cartridge 50.

As an illustrative example of dimensions for the outer housing and bait cartridge and their respective openings and apertures, the outer housing can have an outer diameter of about 5 cm (and can taper from a larger diameter at its top end to a smaller diameter at its bottom end, e.g. 4.5 cm)—not considering anchors 18—and a wall thickness of about 2.5 mm, for example. The sleeve 20, when used, is sized to fit over the outside of at least the bottom portion of the outer housing. The vertical openings 16, 24 in the outer housing can have a length of about 8 to 10 cm and a width of about 3 mm. The openings 16, 24 can be spaced, for example, about 2 cm on center. The bait cartridge can be, for example, about 20 cm long and about 4 cm+/−a mm or so wide. Those skilled in the art will appreciate that this is one example of a configuration in accordance with the invention.

In one embodiment, the station 10 is installed by placement in the ground or other appropriate location for a time sufficient to allow termite infestation. The station or device 10 can be placed in the ground directly by being driven into the soil or placed into a pre-existing hole or location of sufficient dimension to allow the device to remain in position. Once termites are detected in the station by inspection or otherwise, a first bait cartridge comprised predominantly of at least to forms or presentations of a cellulosic termite edible material can be replaced with another cartridge also comprised predominantly of at least to forms or presentations of a cellulosic termite edible material which further contains an effective amount of a non-repellent termiticide. For example, at least one of the cellulose containing materials from which the bait cartridge is constructed such as a corrugated cardboard substrate can be impregnated with the termiticide.

Suitable non-repellent termiticides include the chitin synthesis inhibitors such as hexaflumuron, flufenoxuron, lufenuron and dimilin, juvenile hormone mimics such as methoprene and pyriproxyfen, stomach toxicants such as sulfuramide. Benzoylureas such as lufenuron are particularly suitable. Effective amounts of these materials for use in termite baiting stations to control termites are known to those skilled in the art. For example, the amount of toxicant needed to control termites will vary, depending on the particular toxicant used, but in general an amount between about 1 and about 5,000 parts per million (ppm) of toxicant to bait will be utilized in at least one of the cellulose containing materials; particularly an amount between about 10 and about 2000 ppm may be used, and more particularly between about 50 and about 1500 ppm. In one embodiment, a concentration of about 1500 ppm of lufenuron is employed as toxicant.

In addition, any known termite killing or controlling agent or termiticide can also be used in the practice of the invention in combination with the bait stations of the invention. These include, as noted above, chitin synthesis inhibitors such as hexaflumuron, flufenoxuron, lufenuron and dimilin, juvenile hormone mimics such as methoprene and pyriproxyfen, stomach toxicants such as sulfuramide, as well as abamectin, cryolite, boric acid and alkali and alkaline earth salts of boric acid, and contact insecticides such as thiamethoxam, imidacloprid and fipronil, or mixtures or combinations of these agents.

In yet another embodiment, a plurality of stations 10 are installed around or in the vicinity of a building or wooden structure to reduce the likelihood of termite infestations occurring therein. The present invention also contemplates such a system or array of stations as well as the method for using such system or array alone or in combination with conventional perimeter termiticide spray applications to control termites in the vicinity of a building or wooden structure to be protected.

Examples of termite species which can be controlled by use of the disclosed method include Coptotermes formosanus, Reticulitermes flavipes, R. hesperus, R. virginicus, R. tibialis, and Heterotermes aureus, as well as termite species of the families (and pest genera) Mastotermitidae (Mastotermes species), Hodotermididae (Anacanthotermes, Zootermopsis species), Rhinotermitidae (Coptotermes, Heterotermes, Reticulitermes, Psammotermes, Prorhinotermes, Schedorhinotermes species), Kalotermitidae (Glyptotermes, Neotermes, Cryptotermes, Incisitermes, Kalotermes, Marginitermes species), Serritermitidae, and Termitidae (Pericapritermes, Allodonternes, Microternes, Odontoternes, Nasutiternes, Termes, Amiternes, Globitermes, Microceroternes species), Termopsidae (Hodotermopsis, Zootermopsis species), and other pest species of termites. The stations, systems and methods of the invention have been found to be particularly suitable for controlling subterranean termites.

The following examples describe specific embodiments within the scope of the invention. Other embodiments within the scope of the claims herein will be apparent to one skilled in the art from consideration of the specification or practice of the invention as disclosed herein. It is intended that the specification, together with the examples, be considered exemplary only, with the scope and spirit of the invention being indicated by the claims which follow the examples. In the examples all percentages are given on a weight basis unless otherwise indicated.

### EXAMPLES

Field tests of the station configurations in accordance with the invention were compared with standard configurations as follows:
1. Comparative A: Termite bait station with only interior wood as bait insert, no outer pressed cardboard sleeve.
2. Comparative B: Termite bait station with only interior wood as bait insert and an outer station pressed cardboard sleeve.
3. Invention embodiment A: Termite bait station with interior bait cartridge in accordance with the invention (wood, corrugated cardboard, and pressed cardboard (side wall) tube) (see, e.g., FIGS. 3 and 6) as bait insert, no outer station sleeve.
4. Invention embodiment B: Termite station with interior bait cartridge in accordance with the invention (wood, corrugated cardboard, and pressed cardboard (side wall) tube) (see, e.g., FIGS. 3 and 6) as a bait insert, and an outer station cardboard sleeve (see, e.g., FIGS. 1 and 2).

### Procedure:

There were 10 replications per treatment for a total of 40 reps. The stations were installed in 10 plots (sites). Each plot received a representation of each of the four treatments. The stations were inspected at the following intervals after installation: 1 and 1.5 months. During inspection, the stations were evaluated for the number of termites present and the damage to the bait insert (either interior wood or a bait cartridge in accordance with the invention). A station was assigned one of the following ratings (ratings 4 and 5 make reference to bait cartridge only since no stations with interior wood only received such rating):
0: No termites or damage
1: Slight scoring of bait insert, with less than 20 termites visible
2: Holes in bait insert side wall, along with slight scoring, at least 40 termites visible
3: Significant scoring of bait insert side wall with increased number of termite created holes, over 40 termites present.
4: Top of bait insert packed with dirt, significant consumption of bait cartridge side wall and consumption of inner corrugated cardboard, termites readily visible in tube due to gaps in material, approximately 60-100 termites present.
5: In addition to 4 rating criteria, wood portion of bait cartridge visible in multiple areas due to consumption of cardboard material, 100 plus termites in tube.
   The results are given in the table below:

| | Scale: 0-5 | Scale: 0-5 |
|---|---|---|
| Treatment | 1 month | 1.5 months |
| Trt 1: Comparative A | | |
| Avg | 0.0 | 0.0 |
| # Active Stations | 0 | 0 |
| Trt 2: Comparative B | | |
| Avg | 0.1 | 0.0 |
| # Active Stations | 1 | 0 |
| Trt 3: Invention Embodiment A | | |
| Avg | 0.5 | 0.5 |
| # Active Stations | 3 | 2 |
| Trt 4: Invention Embodiment B | | |
| Avg | 1.0 | 1.5 |
| # Active Stations | 5 | 6 |

The above data indicates that the embodiments A and B in accordance with the present invention (having termite edible material comprising at least two different forms of a cellulose containing material) showed improved termite hit rates over the comparative examples in which bait insert comprised interior wood.

The foregoing description and example are for the purpose of illustration only and does not limit the scope of protection which should be accorded this invention.

What is claimed is:

1. A device for monitoring, detecting and/or controlling subterranean termites comprising:
an outer housing adapted to be implanted in the ground having a plurality of openings through a side wall of the outer housing for passage of termites through the openings into an interior of the outer housing; and
a bait cartridge comprising a major amount of a termite edible material and a minor amount of a termite resistant material, wherein the termite edible material comprises at least two different forms of a cellulose containing material.

2. The device of claim 1, which further comprises a termite-edible sleeve engaged with the side wall of the outer housing and covering at least a portion of said side wall, which sleeve comprises a cellulose containing material having substantially the same form as at least one of the cellulose containing materials from which the bait cartridge is formed.

3. The device of claim 1, wherein the bait cartridge comprises three different forms of a cellulose containing material.

4. The device of claim 1, wherein the upper end of the bait cartridge is open and aligned with the upper end of the outer housing when the bait cartridge is properly installed in the interior of the outer housing.

5. The device of claim 1, wherein the termite resistant material of the bait cartridge includes a plastic reamer joined to the lower end of the side wall to close the lower end thereof.

6. The device of claim 1, wherein the reamer contains a plurality of apertures circumferentially spaced apart about a circumference of the reamer.

7. The device of claim 1, wherein the bait cartridge includes a plastic flange joined to the open upper end thereof.

8. The device of claim 1, wherein the bait cartridge comprises an extractor selected from a handle, strap, string, and cord.

9. The device of claim 8, wherein the extractor comprises a strap having two ends which are attached to and extend up from the plastic reamer to form an upwardly projecting handle.

10. The device of claim 1, wherein the side wall of the bait cartridge is formed of pressed cardboard.

11. The device of claim 1, wherein the interior of the bait cartridge contains corrugated cardboard.

12. The device of claim 1, wherein the interior of the bait cartridge contains a wood piece.

13. The device of claim 2, wherein the outer sleeve is formed of pressed cardboard.

14. The device of claim 1, wherein the cellulose containing material within the interior of the bait cartridge further comprises a non-repellent termiticide.

15. The device of claim 14, wherein the non-repellent termiticide is a chitin synthesis inhibitor.

16. The device of claim 15, wherein the non-repellent termiticide is a benzoylurea.

17. The device of claim 16, wherein the non-repellent termiticide is a lufenuron.

18. The device of claim 1, wherein the cap is a snap cap which frictionally engages the upper end of the outer housing.

19. The device of claim 18, wherein the cap comprises a compression ring to frictionally engage a recessed lip located in the upper end of the outer housing.

20. The device of claim 18, wherein the cap comprises a recessed groove adapted to complimentarily engage and remain attached to a removal device when said device is used to remove the cap.

21. A termite control system, comprising: a plurality of subterranean termite monitoring or baiting stations, two or more of said stations each including a bait cartridge comprising a major amount of a termite edible material and a minor amount of a termite resistant material, wherein the termite edible material comprises at least two different forms of a cellulose containing material, the second one of the stations being spaced apart from the first one of the stations.

22. A method for reducing termite feeding damage in a wooden structure, comprising: installing a plurality of subterranean termite monitoring or baiting stations around the exterior of said structure, two or more of said stations each including a bait cartridge comprising a major amount of a termite edible material and a minor amount of a termite resistant material, wherein the termite edible material comprises at least two different forms of a cellulose containing material, the second one of the stations being spaced apart from the first one of the stations.

23. The method of claim 22, wherein at least one of the cellulose containing materials from which the bait cartridge is formed comprises a non-repellent termiticide.

24. The method of claim 22, wherein a termiticide spray application is made around the perimeter of the wooden structure.

25. The method of claim 24, wherein the termiticide is fipronil.
